(19) United States
(12) Patent Application Publication
(10) Pub. No.: US 2026/0143286 A1
(43) Pub. Date: May 21, 2026

(54) ADJUSTING FEEDBACK CANCELLER ADAPTATION IN RESPONSE TO ENTRAINMENT IN EAR-WORN DEVICES

(71) Applicant: Fortell Research Inc., New York, NY (US)

(72) Inventors: Abraham Neben, Hamden, CT (US); Ryan terMeulen, Watertown, MA (US)

(21) Appl. No.: 19/391,785

(22) Filed: Nov. 17, 2025

Related U.S. Application Data
(60) Provisional application No. 63/720,932, filed on Nov. 15, 2024.

(51) Int. Cl. H04R 25/00

(52) U.S. Cl. CPC H04R 25/453

(57) ABSTRACT

An ear-worn device may include an adaptive feedback filter and control circuitry. The control circuitry may determine a metric value based on coefficients of the adaptive feedback filter at causal delays (longer than minimum electroacoustic propagation time) and acausal delays (shorter than minimum electroacoustic propagation time). The metric may indicate entrainment degree in the adaptive feedback filter. Based on the metric, the control circuitry may adjust filter parameters and/or signal processing operations to mitigate entrainment effects.

### BACKGROUND

### Field

The present disclosure relates to ear-worn devices. Some aspects relate to feedback cancellation.

### Related Art

Ear-worn devices, such as hearing aids, may be used to help those who have trouble hearing to hear better. Typically, ear-worn devices amplify received sound. Some ear-worn devices may attempt to reduce noise in received sound.

### SUMMARY

Ear-worn devices such as hearing aids may be configured to use an adaptive feedback filter to solve for and subtract an acoustic feedback signal in real time. The adaptive filter may be updated based on the correlation between the receiver output and the microphone input. In typical noise or speech, this correlation may be dominated by the actual electroacoustic feedback path from the receiver to the microphone. However, environmental tones may have significant autocorrelation at long lags, which may dominate over the feedback correlation. This may be caused by amplification performed by the ear-worn device, which may cause the receiver signal to be an amplified/delayed version of the microphone signal. This in turn may cause the adaptive filter to become unstable and actually inject tonal artifacts into the signal (also referred to as entrainment).

This application describes ear-worn devices with improved adaptive feedback filtering. In some aspects, an ear-worn device may be configured to determine a metric based on coefficients of an adaptive feedback filter at causal delays and coefficients at acausal delays, where the metric may indicate a degree of entrainment in the adaptive feedback filter. The ear-worn device may be configured to adjust parameters of the adaptive feedback filter or other signal processing operations based on the metric to mitigate entrainment effects.

### BRIEF DESCRIPTION OF DRAWINGS

FIG. 1 illustrates a hearing aid, in accordance with certain embodiments described herein;

FIG. 2 illustrates circuitry in an ear-worn device, in accordance with certain embodiments described herein;

FIG. 3 illustrates a block diagram of a finite impulse response (FIR) filter, in accordance with certain embodiments described herein; and

FIG. 4 illustrates a conceptual example of minimum electroacoustic propagation time, in accordance with certain embodiments described herein.

### DETAILED DESCRIPTION

The aspects and embodiments described above, as well as additional aspects and embodiments, are described further below. These aspects and/or embodiments may be used individually, all together, or in any combination of two or more, as the disclosure is not limited in this respect.

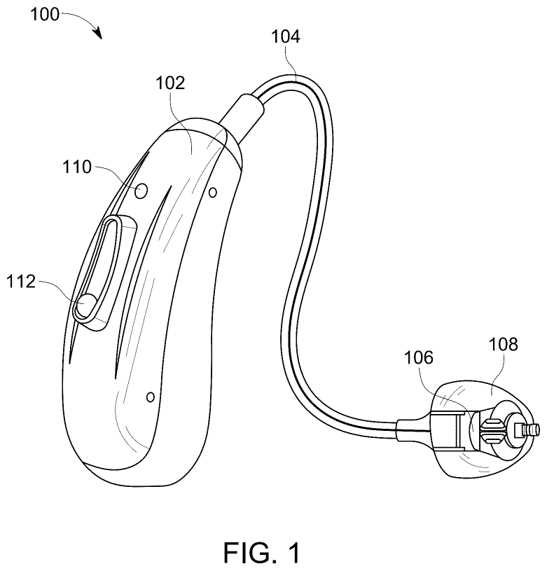

FIG. 1 illustrates a hearing aid 100, in accordance with certain embodiments described herein. The hearing aid 100 may be any of the ear-worn devices or hearing aids described herein. The hearing aid 100 is a receiver-in-canal (RIC) (also referred to as a receiver-in-the-ear (RITE)) type of hearing aid. However, any other type of hearing aid (e.g., behind-the-ear, in-the-ear, in-the-canal, completely-in-canal, open fit, etc.) may also be used. The hearing aid 100 includes a body 102, a receiver wire 104, a receiver 106, and a dome 108. The body 102 is coupled to the receiver wire 104 and the receiver wire 104 is coupled to the receiver 106. The dome 108 is placed over the receiver 106. The body 102 includes a microphone 110 and a user input device 112. The body 102 additionally includes circuitry (e.g., any of the circuitry described hereinafter, aside from the receiver 106) not illustrated in FIG. 1. The microphone 110 may be configured to receive sound signals and generate audio signals based on the sound signals. While FIG. 1 illustrates one microphone for simplicity, it should be appreciated that the hearing aid 100 may have two or more microphones. The user input device 112 (e.g., a button) may be configured to control certain functions of the hearing aid 100, such as volume, activation of neural network-based denoising, etc.

The receiver wire 104 may be configured to transmit audio signals from the body 102 to the receiver 106. The receiver 106 may be configured to receive audio signals (i.e., those audio signals generated by the body 102 and transmitted by the receiver wire 104) and generate sound signals based on the audio signals. The dome 108 may be configured to fit tightly inside the wearer's ear and direct the sound signal produced by the receiver 106 into the ear canal of the wearer.

In some embodiments, the length of the body 102 may be equal to 2 cm, equal to 5 cm, or between 2 and 5 cm in length. In some embodiments, the weight of the hearing aid 100 may be less than 4.5 grams. In some embodiments, the spacing between the microphones may be equal to 5 mm, equal to 12 mm, or between 5 and 12 mm. In some embodiments, the body 102 may include a battery (not visible in FIG. 1), such as a lithium ion rechargeable coin cell battery.

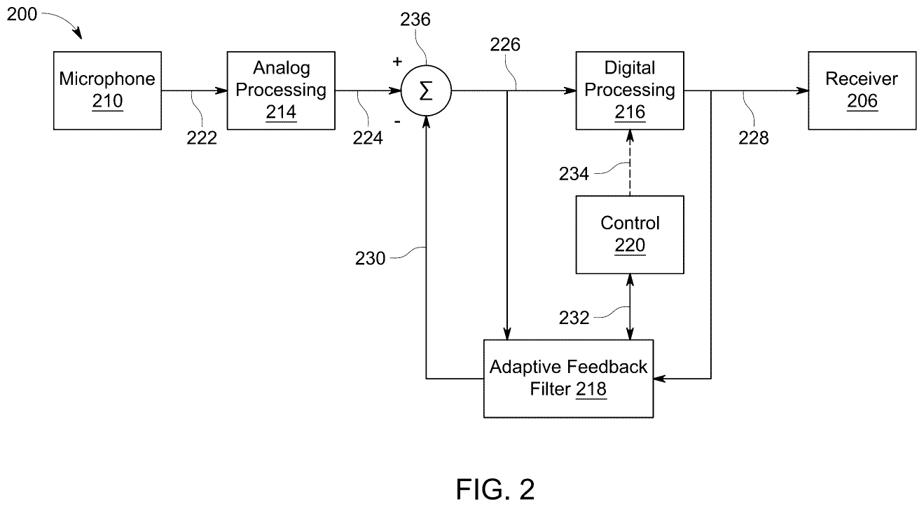

FIG. 2 illustrates circuitry in an ear-worn device 200, in accordance with certain embodiments described herein. The ear-worn device 200 may be, for example, a hearing aid (e.g., the hearing aid 100), a cochlear implant, an earphone, eyeglasses with built-in hearing aids, etc. FIG. 2 illustrates a microphone 210 (which may correspond to the microphone 110), analog processing circuitry 214, digital processing circuitry 216, a receiver 206 (which may correspond to the receiver 106), an adaptive feedback filter 218, control circuitry 220, and a summer 238. It should be appreciated that the ear-worn device 200 may include more circuitry and components than shown (e.g., anti-feedback circuitry, calibration circuitry, etc.) and such circuitry and components may be disposed before, after, or between the circuitry and components of FIG. 2.

The microphone 210 may be configured to receive a sound signal and generate an audio signal 222 based on the sound signal. (It should be appreciated that when the ear-worn device 200 includes multiple microphones, adaptive feedback cancellation as described below may be performed separately for each.) The analog processing circuitry 214 may be configured to perform, for example, one or more of analog preamplification and analog filtering. The analog processing circuitry 214 may also be configured to perform analog-to-digital conversion. Thus, the output of the analog processing circuitry 214 may be a digital audio signal 224. Description of the operation of the summer 236 may be found below. The digital processing circuitry 216 may be configured to perform, for example, one or more of wind reduction, input calibration, beamforming, noise reduction, wide-dynamic range compression, and output calibration on the audio signal 226 from the summer 236. The output of the digital processing circuitry 216 may be an audio signal 228. The receiver 206 may be configured to play back the audio signal 228 as sound into the ear of the wearer. The receiver 206 may be configured to perform digital-to-analog conversion on the audio signal 228 to convert it to a sound signal.

As described, the adaptive feedback filter 218 may be configured to solve for and subtract an acoustic feedback signal in real time. The adaptive feedback filter 218 may be updated based on the correlation between the receiver output (in FIG. 2, the audio signal 228) and an audio signal from a microphone (in FIG. 2, the audio signal 226). Based on this correlation, the adaptive feedback filter 218 may be configured to output a prediction of the feedback, which in FIG. 2 is the feedback signal 230. The summer 236 may be configured to add the audio signal 224 to the inverse of the feedback signal 230 (or in other words, subtract the feedback signal 230 from the audio signal 224), thereby generating the audio signal 226 for input to the digital processing circuitry 216.

The adaptive feedback filter 218's behavior may be determined by its update equation, which typically has parameters related to adaptation rate and coefficient leakage (or decay). A faster adaptation rate may allow the adaptive feedback filter 218 to respond more quickly to changes in the acoustic feedback path, but the adaptive feedback filter 218 may have more “noise” in the steady state and may entrain faster. Larger leakage may prevent the filter coefficients from drifting when the feedback path is weak and may help the adaptive feedback filter 218 recover faster when it has been entrained, but may limit adaptation accuracy when the feedback path is strong.

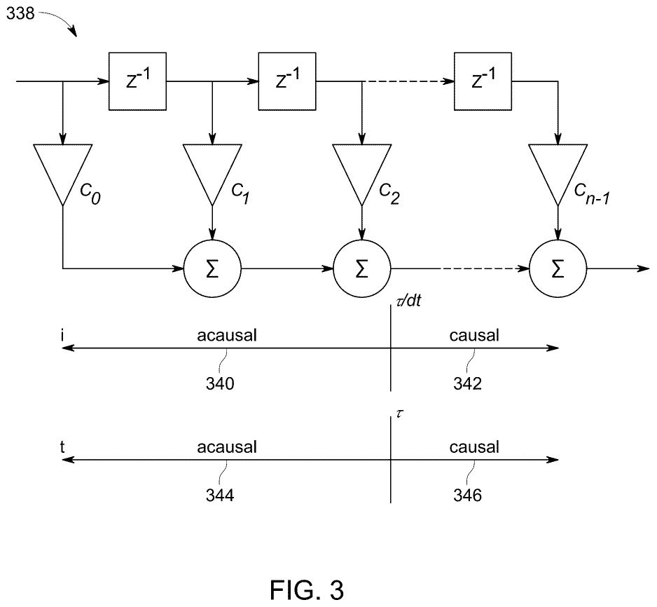

FIG. 3 illustrates a block diagram of a finite impulse response (FIR) filter 338, in accordance with certain embodiments described herein. The FIR filter 338 may be implemented by the adaptive feedback filter 218. The FIR filter 338 includes delays z⁻¹, filter coefficients c₀ . . . cₙ (this description may generally refer to filter coefficient(s) as cᵢ) and summers Σ. Let the FIR filter 338 at time t have coefficients cᵢ(t) for i=0 . . . n−1, where n is the number of feedback filter taps (which is the same as the number of coefficients). Let the leakage be λ, and let the adaptation rate be n. Let dt=1/fs be the sample period, where fs is the sample frequency. Then at each time step, the coefficients may be updated to

$${c}_{i} ( t + dt ) = ( 1 - λ ) * {c}_{i} ( t ) + η * [ e ( t ) * y ( t - i * dt ) ] / {σ}^{2} ( t )$$

The expected feedback signal may be y(t)=Σ_{□=0} f (t−i*dt)*cᵢ(t), where f(t) is the output signal from the ear-worn device. The feedback-subtracted microphone input, also known as the error signal, is e(t). The mean power is σ²(t)=sqrt[<err²(t)><y²(t)>]. In some embodiments, a block-update approach may be used, such that instead of updating the filter coefficients at every time step, a block of data is received, and the filter updates are summed for the full block of samples.

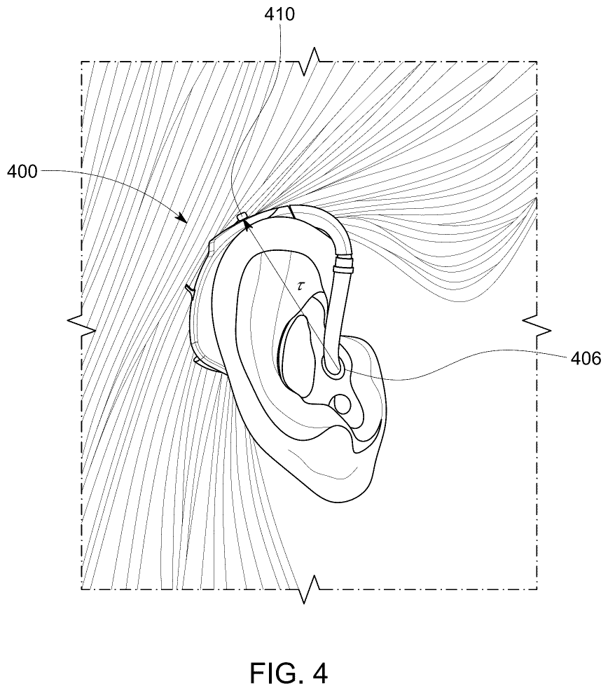

In some embodiments, the adaptive feedback filter 218 may be configured to operate in the time domain. In other embodiments, multiple adaptive feedback filters may be configured to operate on different sub-bands in the frequency domain. Both types of embodiments may provide information about the time-delay of the feedback path being modeled. A physical feedback path may exhibit signal above a minimum electroacoustic propagation time. FIG. 4 illustrates a conceptual example of minimum electroacoustic propagation time, in accordance with certain embodiments described herein. FIG. 4 illustrates a hearing aid 400 (which may correspond to the hearing aid 100, and which may be an example of the ear-worn device 200) including a microphone 410 (which may correspond to the microphone 110 and/or 210) and a receiver 406 (which may correspond to the receiver 106 and/or 206). FIG. 4 illustrates conceptually the minimum electroacoustic propagation time τ from the receiver 406 to the microphone 410. The minimum electroacoustic propagation time τ may be a function of the position of the receiver 406 in three-dimensional space relative to the microphone 410, as well as the electroacoustic properties of the system. In some embodiments, the minimum electroacoustic propagation time τ in the ear-worn device 400 may be between 0.1-0.9 milliseconds. In some embodiments, the minimum electroacoustic propagation time τ in the ear-worn device 400 may be between 0.2-0.8 milliseconds. In some embodiments, the minimum electroacoustic propagation time τ in the ear-worn device 400 may be between 0.3-0.7 milliseconds. In some embodiments, the minimum electroacoustic propagation time τ in the ear-worn device 400 may be between 0.4-0.6 milliseconds. In some embodiments, the minimum electroacoustic propagation time τ in the ear-worn device 400 may be approximately equal to 0.5 milliseconds.

As described above, a physical feedback path may exhibit signal above a minimum electroacoustic propagation time τ, but entrainment may typically exhibit signal at all time lags, including those representing unrealistically fast (or acausal) electroacoustic propagation. The term “acausal delays” may be used for delays shorter than the minimum electroacoustic propagation time τ, and the term “causal delays” may be used for delays longer than or equal to t. The acausal part of the adaptive feedback filter 218 may be {cᵢ} for 0≤i<τ/dt, and the causal part of the adaptive feedback filter 218 may be {cᵢ} for τ/dt≤i<n. (It should be appreciated that other embodiments may include delays equal to t in the acausal delays.)

Returning to FIG. 3, FIG. 3 illustrates the acausal part 340 and the causal part 342 of the example FIR filter 338. The acausal part 340 may include those coefficients cᵢ for which 0≤i<τ/dt and the causal part 342 may include those coefficients cᵢ for which τ/dt≤i<n. From another perspective, FIG. 3 may illustrate those coefficients at acausal delays 344 for which 0≤t<τ and those coefficients at causal delays 346 for which τ≤t.

The inventors have developed technology that may use a continuous feedback metric (which may be referred to herein as feedback_metric). Returning to FIG. 2, this description will describe the control circuitry 220 as determining the metric and controlling the ear-worn device 200 based on the metric. FIG. 2 therefore illustrates one or more signals 232 between the control circuitry 220 and the adaptive feedback filter 218, where the one or more signals may include filter coefficients for the adaptive feedback filter 218 received by the control circuitry 220 and/or control signals transmitted to the adaptive feedback filter 218. FIG. 2 also illustrates one or more optional control signals 234 from the control circuitry 220 to the digital processing circuitry 216.

Generally, then, an ear-worn device (e.g., the ear-worn device 200) may include an adaptive feedback feedback filter (e.g., the adaptive feedback filter 218) and control circuitry (e.g., the control circuitry 220). The control circuitry 220 may be configured to determine a value for a metric based on for one or more of the coefficients cᵢ of the adaptive feedback filter 218 at causal delays 346 and values for one or more of the coefficients cᵢ of the adaptive feedback filter 218 at acausal delays 344. As described above, acausal delays 344 may include delays shorter than the minimum electroacoustic propagation time τ for the adaptive feedback filter 218 and causal delays 346 may include delays longer than the minimum electroacoustic propagation time τ for the adaptive feedback filter 218. In some embodiments, the metric may be a continuous metric.

In some embodiments, the metric may be based on the difference between one of the coefficients cᵢ at causal delays 346 and one of the coefficients cᵢ at acausal delays 344. In some embodiments, the metric may be based on the difference between the maximum of the coefficients cᵢ at causal delays 346 and the maximum of the coefficients cᵢ at acausal delays 344. As a specific example, the ear-worn device 200 (and in the example of FIG. 2, specifically the control circuitry 220) may be configured to measure the maximum causal feedback filter coefficient, as well as the maximum acausal feedback filter coefficient, and define a continuous feedback metric as:

$$feedback\_metric ( t ) = max\_causal \_coef ( t ) - max\_acausal \_coef ( t )$$

where

$$max\_acausal \_coef ( t ) = max \{ \vert {c}_{i} ( t ) \vert \} over 0 \leq i < τ / dt , and$$

$$max\_causal \_coef ( t ) = max \{ \vert {c}_{i} ( t ) \vert \} over τ / dt \leq i < n$$

It should be appreciated that some other embodiments may use a feedback metric equal to max_acausal_coef(t)−max_causal_coef(t). Generally, when the metric indicates a decrease in the difference between the coefficient (e.g., the maximum coefficient) at causal delays 346 and the coefficient (e.g., the maximum coefficient) at acausal delays 344, this may indicate an increase in entrainment, and an increased degree of entrainment mitigation (described below) may be implemented.

In some embodiments, the metric may be based on the ratio of the power of one or more of the coefficients cᵢ at causal delays 346 to the power of one or more of the coefficients cᵢ at acausal delays 344. The ratio may be expressed in decibels. As a specific example, the continuous feedback metric may be defined as:

$$feedback\_metric ( t ) = 10 * log 10 \{ causal\_pwr ( t ) / acausal\_pwr ( t ) \}$$

where

$$acausal\_pwr ( t ) = mean \{ {{c}_{i} ( t )}^{2} \} over 0 \leq i < τ / dt , and$$

$$causal\_pwr ( t ) = mean \{ {{c}_{i} ( t )}^{2} \} over τ / dt \leq i < n$$

It should be appreciated that some other embodiments may use a feedback metric equal to 10*log 10{acausal_pwr(t)/causal_pwr(t)}. Generally, when the metric indicates a decrease in the power of the coefficients cᵢ at causal delays 346 versus the power of the coefficients cᵢ at acausal delays 344, this may indicate an increase in entrainment, and an increased degree of entrainment mitigation (described below) may be implemented.

Following is a description of various mitigations that the ear-worn device (and in the example of FIG. 2, specifically the control circuitry 220) may be configured to implement based on the metric. As described above, in the example of FIG. 2, the control circuitry 220 may be configured to control the adaptive feedback filter 218 through the one or more signals 232. In some embodiments, based on the metric, the ear-worn device 200 may be configured to vary the adaptation rate parameter of the adaptive feedback filter 218. In some embodiments, based on the metric, the ear-worn device 200 may be configured to vary the leakage parameter of the adaptive feedback filter 218. In some embodiments, based on the metric, the ear-worn device 200 may be configured to vary both the adaptation rate parameter and the leakage parameter of the adaptive feedback filter 218.

Generally, in some embodiments, the ear-worn device 200 (and in the example of FIG. 2, specifically the control circuitry 220) may be configured to control the ear-worn device 200 to perform an entrainment mitigation based on the value for the metric. In more detail, in a scenario of increased entrainment (as indicated by the metric), in some embodiments the ear-worn device 200 may be configured to increase the ratio of the leakage parameter to the adaptation rate parameter. This may be accomplished by at least one of increasing the leakage parameter and decreasing the adaptation rate (i.e., increasing the leakage parameter, decreasing the adaptation rate, or a combination of the two). In some embodiments, in a scenario of increased entrainment (as indicated by the metric), the ear-worn device 200 may be configured to decrease both the leakage parameter and the adaptation rate parameter such that the ratio of the leakage parameter to the adaptation rate parameter remains constant.

As described above, in the example of FIG. 2, the control circuitry 220 may be configured to control the digital processing circuitry 216 through the one or more signals 234. In some embodiments, based on the metric, the ear-worn device 200 may be configured to vary a gain (e.g., temporarily lower the gain) applied (e.g., by the digital processing circuitry 216) to microphone signals (e.g., the audio signals 226), perform frequency shifting on microphone signals once amplified, and/or add jitter to the amplified microphone signals. This may cause decorrelation of the output signal (e.g., the audio signal 228) relative to the input signal (e.g., the audio signal 226). In particular, in a scenario of increased entrainment (as indicated by the metric), the ear-worn device 200 may be configured to lower gain, frequency shift (which may be in either direction), and/or add jitter.

Below is a description of how the ear-worn device 200 may behave for several discrete values of a metric of the form feedback_metric(t)=max_causal_coef(t)−max_acausal_coef(t). It should be appreciated that the parameters described below may be varied continuously as a function of feedback_metric. When feedback_metric (or generally, a difference between one of the coefficients at the causal delays and one of the coefficients at the acausal delays) is either negative, or positive and smaller than a first threshold, then the adaptive feedback filter 218 may be dominated by entrainment and/or noise. Regardless, a low adaptation rate and a high leakage may be set. When feedback_metric (or generally, a difference between one of the coefficients at the causal delays and one of the coefficients at the acausal delays) is positive and larger than a second threshold, the feedback path may be strong, and may dominate over any entrainment, and thus the adaptation rate may be set high and the leakage set low.

Consider a user who typically has a weak feedback path. For this user, the feedback canceller may be running mainly to prevent occasional feedback (e.g., due to their hand reaching up near their ear, or standing in an elevator with their head close to the wall). The feedback metric may typically be small, so a low adaptation rate and large leakage may be used. Entrainment may decrease the feedback metric, and thus the adaptation rate may remain low, limiting entrainment artifacts. Now consider a user who may typically have a strong feedback path. For this user, the feedback metric may typically be high, meaning the adaptation rate may be high and the leakage may be low. Entrainment may cause the feedback metric to shrink modestly, so the adaptation rate may be modestly reduced and the leakage increased.

As described above, generally, control circuitry in an ear-worn device may be configured to determine a value for a metric (e.g., any of those described herein) and control the ear-worn device to perform an entrainment mitigation (e.g., any of the mitigations described herein) based on the value for the metric. In some embodiments, the control circuitry may be considered separate from the adaptive feedback filter (as in the example of FIG. 2). In some embodiments, the control circuitry may be considered part of the adaptive feedback filter.

It should be appreciated that a method of operating an ear-worn device (e.g., the ear-worn device 200) having an adaptive feedback filter (e.g., the adaptive feedback filter 218) may include determining a value for a metric based on values for one or more coefficients of the adaptive feedback filter at causal delays and values for one or more of the coefficients of the adaptive feedback filter at acausal delays (where the acausal delays comprise delays shorter than a minimum electroacoustic propagation time for the adaptive feedback filter and the causal delays comprise delays longer than the minimum electroacoustic propagation time for the adaptive feedback filter), and controlling the ear-worn device to perform an entrainment mitigation based on the value for the metric.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. An ear-worn device, comprising:
an adaptive feedback filter; and
control circuitry configured to:
determine a value for a metric based on values for one or more coefficients of the adaptive feedback filter at causal delays and values for one or more of the coefficients of the adaptive feedback filter at acausal delays, wherein the acausal delays comprise delays shorter than a minimum electroacoustic propagation time for the adaptive feedback filter and the causal delays comprise delays longer than the minimum electroacoustic propagation time for the adaptive feedback filter.

2. The ear-worn device of claim 1, wherein the metric comprises a continuous metric.

3. The ear-worn device of claim 1, wherein the metric is based on a difference between one of the coefficients at the causal delays and one of the coefficients at the acausal delays.

4. The ear-worn device of claim 1, wherein the metric is based on a difference between a maximum of the coefficients at the causal delays and a maximum of the coefficients at the acausal delays.

5. The ear-worn device of claim 1, wherein the metric is based on a ratio of power of one or more of the coefficients at causal delays to power of one or more of the coefficients at acausal delays.

6. The ear-worn device of claim 1, wherein the control circuitry is further configured, based on the value for the metric, to vary an adaptation rate parameter for the adaptive feedback filter.

7. The ear-worn device of claim 1, wherein the control circuitry is further configured, based on the value for the metric, to vary a leakage parameter for the adaptive feedback filter.

8. The ear-worn device of claim 1, wherein the control circuitry is further configured, based on the value for the metric, to vary an adaptation rate parameter and a leakage parameter for the adaptive feedback filter.

9. The ear-worn device of claim 1, wherein the control circuitry is further configured, based on the value for the metric, to:
vary a gain applied to microphone signals;
perform frequency shifting on the microphone signals once amplified; and/or
add jitter to the microphone signals once amplified.

10. The ear-worn device of claim 1, wherein the control circuitry is further configured to control the ear-worn device to perform an entrainment mitigation based on the value for the metric.

11. The ear-worn device of claim 10, wherein the entrainment mitigation comprises increasing a ratio of a leakage parameter for the adaptive feedback filter to an adaptation rate parameter for the adaptive feedback filter when the metric indicates increased entrainment.

12. The ear-worn device of claim 11, wherein increasing the ratio of the leakage parameter to the adaptation rate parameter comprises at least one of increasing the leakage parameter and decreasing the adaptation rate parameter.

13. The ear-worn device of claim 12, wherein increasing the ratio of the leakage parameter to the adaptation rate parameter comprises decreasing both the leakage parameter and the adaptation rate parameter such that the ratio of the leakage parameter to the adaptation rate parameter remains constant.

14. The ear-worn device of claim 1, wherein the control circuitry is configured to set a low adaptation rate parameter and a high leakage parameter for the adaptive feedback filter when a difference between one of the coefficients at the causal delays and one of the coefficients at the acausal delays is negative or positive and smaller than a first threshold.

15. The ear-worn device of claim 1, wherein the control circuitry is configured to set a high adaptation rate parameter and a low leakage parameter when a difference between one of the coefficients at the causal delays and one of the coefficients at the acausal delays is positive and larger than a second threshold.

16. The ear-worn device of claim 1, wherein the minimum electroacoustic propagation time is between 0.1 and 0.9 milliseconds.

17. The ear-worn device of claim 1, wherein the minimum electroacoustic propagation time is between 0.2 and 0.8 milliseconds.

18. The ear-worn device of claim 1, wherein the minimum electroacoustic propagation time is between 0.3 and 0.7 milliseconds.

19. The ear-worn device of claim 1, wherein the minimum electroacoustic propagation time is between 0.4 and 0.6 milliseconds.

20. A method of operating an ear-worn device having an adaptive feedback filter, the method comprising:
determining a value for a metric based on values for one or more coefficients of the adaptive feedback filter at causal delays and values for one or more of the coefficients of the adaptive feedback filter at acausal delays, wherein the acausal delays comprise delays shorter than a minimum electroacoustic propagation time for the adaptive feedback filter and the causal delays comprise delays longer than the minimum electroacoustic propagation time for the adaptive feedback filter; and
controlling the ear-worn device to perform an entrainment mitigation based on the value for the metric.
